(19) United States
(12) Patent Application Publication
(10) Pub. No.: US 2011/0153468 A1
(43) Pub. Date: Jun. 23, 2011

(54) INVENTORY MANAGEMENT SYSTEM AND METHOD

(76) Inventor: Thomas Roethling, Niagara On The Lake (CA)

(21) Appl. No.: 12/642,384

(22) Filed: Dec. 18, 2009

(51) Int. Cl. G06Q 10/00

(52) U.S. Cl. 705/28

(57) ABSTRACT

An inventory management system and method are disclosed wherein the inventory management system comprises a central database populated with product information from a supplier catalog from at least two suppliers wherein the product information is standardized into a common format; software capable of extracting the product information from the central database and inputting the product information into an end-user database; and an inventory management computer program running in the end-user database keeping track of end-user product inventory.

### BACKGROUND OF THE INVENTION

1. Field of the Invention

This invention relates to an inventory management system and method of using the same. More particularly, the invention relates to a system and method of collecting and standardizing wholesaler, vendor and/or supplier data, and making the standardized data available to retailers and/or other suitable end-users. This invention relates to an inventory management system and method for use by jewelry wholesalers, vendors, suppliers, and/or retailers.

2. Background

To run a successful business, it is important for retailers to have a detailed, up-to-date record of their inventory. With the advent of computers, inputting and tracking inventories has been eased by inventory management software. Nevertheless, retailers presently using inventory management software still need to manually enter into their system any new merchandise being received at their store. This manual data entry is time consuming and costly. Furthermore, manual entry is subject to several kinds of user error, such as inaccuracies, and untimeliness.

Some wholesalers and vendors have started to supply retailers with product data in electronic format. Retailers, especially jewelers, have many different data-fields that are required to be filled when entering inventory. The properties of an item of jewelry can be highly detailed, such as the metal used, size, width, length, weight, gender, or whether for a special occasion. Diamonds and precious and semi-precious gem stones can require upwards of 10 to 14 item fields. Wholesalers and vendors can supply retailers with a data file containing all of the wholesaler's or vendor's product information, i.e. an electronic product catalog. However, this approach has several drawbacks. First, the retailer will have to import the entire catalog into their inventory management software even though that retailer may never carry or order a majority of the products. Another drawback to this type of system is that if vendors update their products catalog, each database for every individual retailer would need to be updated also. Second, and more importantly, nearly every wholesaler or vendor supplies information in a different format. This lack of standardization greatly increases the difficulty in importing the information into the retailer's inventory software, and as a result, the retailer commonly inputs the data manually. Thus, user error and timeliness are not alleviated, but are exacerbated using this approach.

Various inventory management systems have been invented to increase supply chain efficiencies and vendor/retailer communication. For example U.S. Pat. No. 7,363,249 issued to Boesjes discloses a multiply-integrated system for inventory, sales, and distribution of products which has a supplier database, an order database, and an order processor. The supplier database collects product and pricing information from a variety of manufacturers, distributors, and/or retailers. When an order is placed by a consumer, the order database finds which party in the supply chain has the item and sends a shipping request. Once the item has been shipped, the order database automatically updates to reflect the shipment. The order database further tracks the number of orders and number of shipments made. However, the Boesjes patent focuses on order placement and fulfillment, not on inventory management. The problem with this system is that it does not deal with the difficulties in listing inventory and supplying this data to vertical members of a supply chain. It only looks at what suppliers have listed as their inventory in determining which vendor to use in fulfilling an order. This system does not allow for the manipulation of data nor the standardization of vendor data.

U.S. Pat. No. 6,115,641 (Brown, et al) teaches a computer based catalog system available to members of a network. Members include manufacturers, distributors, and/or retailers. The system stores an electronic version of manufacturers' catalogs. Other members down the supply chain can access these catalogs and include manufacturer supplied data in their own electronic catalogs. When a manufacturer makes changes to a stored catalog, those changes are automatically updated within the distributor and/or retailer catalogs. Although the Brown patent does supply inventory data, there is no manipulation of the electronic data into a standardized form. This system presents another problem in that each manufacturer can have a different format and include different, and possibly irrelevant, information. This makes data integration less efficient for members downstream and likely necessitates manual data manipulation leading to possible data entry errors. Additionally, those downstream of the manufacturer collect not only data for the particular items to be inventoried, but the entire catalog of information. Thus, downstream members have to sift through superfluous data to find the specific item to be inventoried and then manual extract the relevant data from the catalog listing so that it may be entered into their own inventory management program.

United States Patent Application No. 2006/0265288 (Aronson) discloses a system for vertically integrating consumers, retailers, and wholesalers—particularly those dealing with diamonds and other forms of jewelry. The consumer searches a retailer's inventory database to find an item that the consumer desires. The database displays the item and the retail price. The retailer views the inventory database and can see the wholesale price for the same desired item. This system facilitates a sale by defining a price range in which the retailer can sell the item while still making a profit. The problem with this method is that there is no way to collect and integrate into a standardized format the multiple information fields provided by wholesaler/vendor/supplier item descriptions. Nor does this system address the problem of managing inventory, but merely aids both retailer and purchaser when trying to make a sale.

Thus it is readily apparent that there is a long-felt need for an inventory management system which collects and standardizes disparate wholesaler/vendor/supplier product data for downstream distribution to retailers and/or purchasers, and takes the standardized data for retailer-selected products and easily downloads the data into the retailer's inventory management software.

### SUMMARY OF THE INVENTION

It is accordingly a primary object of the present invention to provide an inventory management system which collects and manages product information from a multiplicity of diverse suppliers.

Another object of the invention is to provide an inventory management system which standardizes product information collected from any supplier into a common format.

Yet another object of the invention is to provide an inventory management system which supplies standardized product information collected from any number of suppliers to any number of retailers.

A further object of the invention is to provide an inventory management system which supplies standardized product information collected and managed from any number of suppliers to any number of retailers wherein the retailers selectively download only that product information for those products currently being inventoried or ordered by the retailer.

A yet further object of the invention is to provide an inventory management system which supplies standardized product information collected and managed from any number of jewelry suppliers to any number of jewelry retailers wherein the retailers selectively download only that product information for those pieces of jewlery currently being inventoried or ordered by the retailer.

A still further object of the invention is to provide an inventory management system which populates a merchandise purchase order with standardized product information housed on a central database.

Yet a still further object of the invention is to provide an inventory management system which populates a merchandise purchase order with standardized product information housed on a central database and further populates a retailer's inventory once the items ordered on the purchase order have been received by the retailer.

The above and other objects are accomplished in accordance with the present invention by providing an inventory management system and method which enables a retailer to download and manage, within the inventory management and point of sale software, all information provided by the wholesaler or vendor. The inventory management system and method comprises: a central database which is populated with product information from multiple vendors, and inventory software which allows retailers to access and download specified product information from the central database. Data collected from multiple vendors is entered into the central database and is standardized into specific form fields. Retailers can then access the database using specially designed software and download the inventory information by selecting the vendor who supplied the product and the specific item to be inventoried. The standardized information is automatically inserted into the correct form fields within the retailer's inventory management program. Retailers can also choose to only import a selected portion of the product information. In the case of jewelry, this product information can consists of information such as the metal used, size, width, length, weight, gender, or whether for a special occasion, and the like. Further, when placing an order, retailers can select specific vendor pieces stored in the database and the database will then populate the purchase order form for each vendor with the appropriate information inserted into the correct form fields.

These and other objects, features, and advantages of the present invention will become apparent upon a reading of the detailed description and claims in view of the several drawing figures.

### BRIEF DESCRIPTION OF THE DRAWINGS

The present invention and the manner in which it may be practiced is further illustrated with reference to the accompanying drawings wherein:

FIG. 1 is a flow chart depicting a current method for managing inventory.

FIG. 2 is a screenshot depicting a software program used for the manual inputting of inventory data.

FIG. 3 is a flow chart depicting a method for managing inventory as in one embodiment of the present invention.

FIG. 4 is a screenshot depicting a software program used in a method for managing inventory as in one embodiment of the present invention.

FIG. 5 is a flow chart depicting a method for managing inventory as in a second embodiment of the present invention.

FIG. 6 is a screenshot depicting a software program used in a method for managing inventory as in second embodiment of the present invention.

FIG. 7 is a screenshot depicting a software program used in a method for managing inventory as in second embodiment of the present invention wherein inventory data is automatically recalled and displayed.

FIG. 8 is a schematic of an inventory management system of an embodiment of the present invention.

### DETAILED DESCRIPTION OF THE INVENTION

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

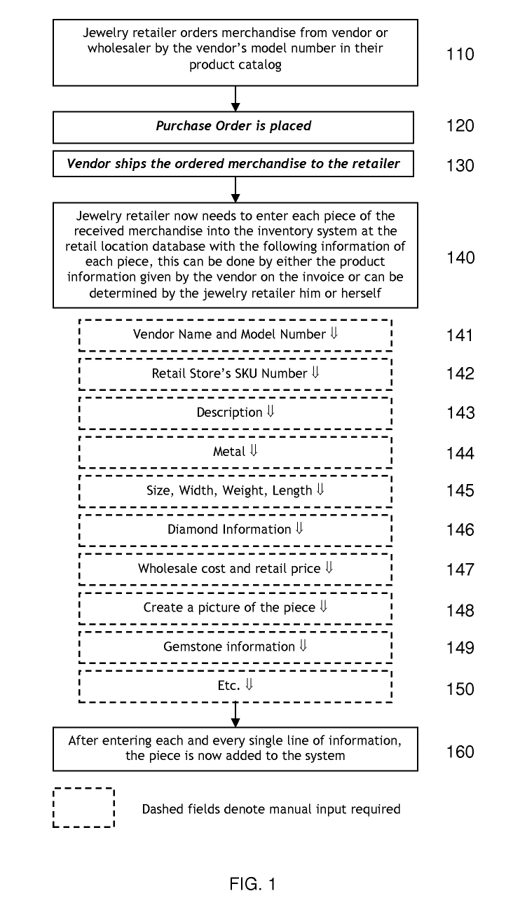

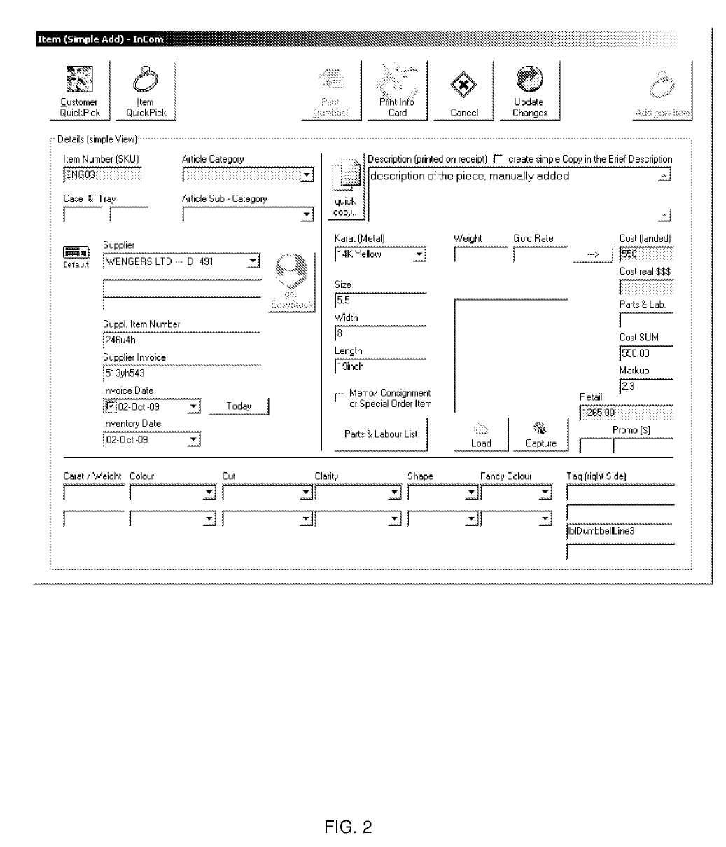

Adverting now to the drawings, FIG. 1 illustrates an inventory management system currently used by most retailers. Step 110 has a retailer preparing an order for merchandise from a vendor using the model number found in the vendor product catalog. This purchase order is then submitted to the vendor as shown in Step 120. In Step 130, the vendor ships the ordered merchandise to the retailer. Step 140 encompasses the retailer manually inputting the received merchandise into the retailer's inventory management system. Steps 141 through 150 illustrate examples of the numerous product descriptors which have to be manually inputted by the retailer. In the case of jewelry, these descriptors can include, among others, the metal used; the size, width, weight, length, etc. of the piece; the wholesale and retail prices; and any gemstone or diamond information. The retailer is required to transcribe information from the vendor catalog or from the product invoice into the inventory management system. Each vendor catalog or invoice contains different information located in different locations. Each retailer has to manually hunt and peck to find the required information. This antiquated inventory management approach is time-consuming, annually taking hundreds of man-hours to complete, and inefficient replete with human input errors. Finally, after all of the information is inputted, the merchandise is added to the inventory within the inventory management system (Step 160). Although not a preferred embodiment of the present invention, the software system of the present invention is capable of completing this type of inventory management. FIG. 2 displays a screenshot of the software output of the present invention wherein inventory management is through manual input.

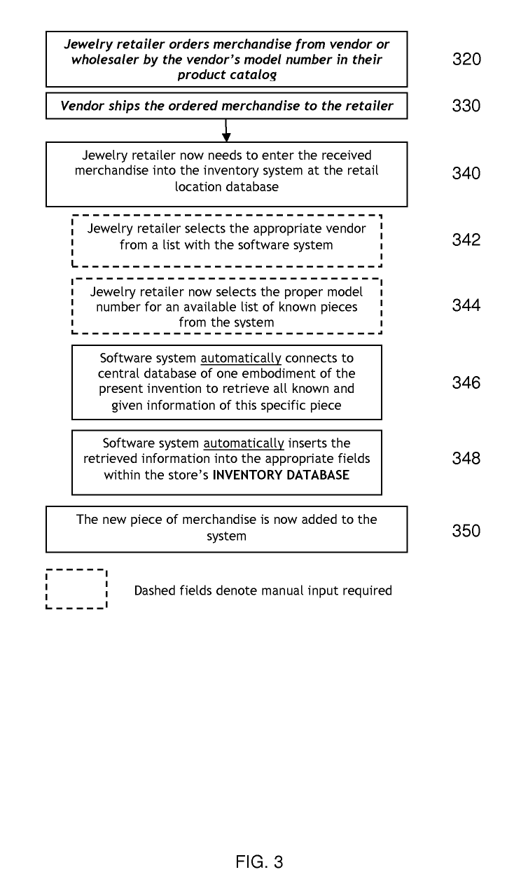

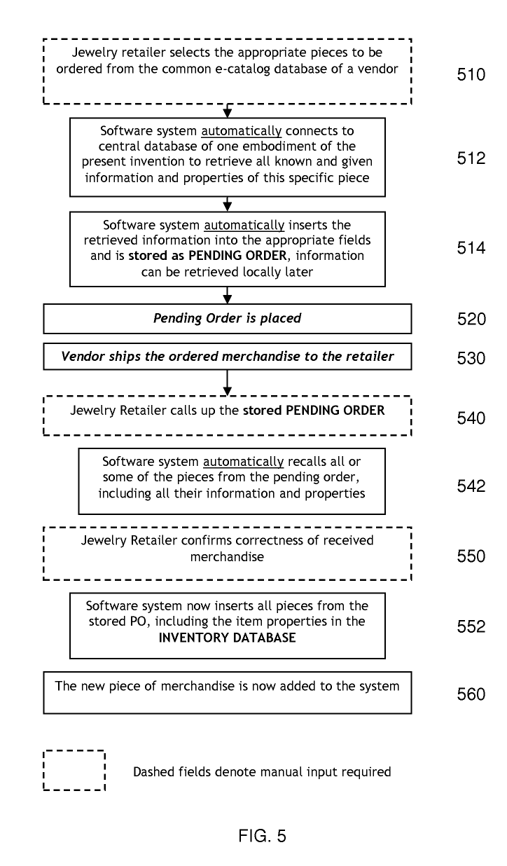

The inventory management system of a preferred embodiment of the present invention operates as shown in FIG. 3 and comprises a central database populated with supplier catalog information from at least two suppliers wherein the catalog information is standardized into a common format; an end-user database comprising an inventory management program populated with catalog information selectively extracted from the central database; and software capable of extracting the selected information from the central database and inputting the selected information into the inventory management program. In Step 320, a retailer orders merchandise from a vendor or wholesaler by using the supplier's catalog-supplied model number. The merchandise is shipped to the retailer by the vendor in Step 330. The next steps, utilizing the inventory management system of the present invention and its method of inputting inventory information differ greatly between the current methodology (FIG. 1) and the system and method in one embodiment of the present invention (FIG. 3). Firstly, manual input by the retailer in one embodiment of the present invention is limited to selecting the appropriate vendor within the inventory software system (Step 342) and then selecting the model number of the piece of merchandise to be inventoried (Step 344). These selections can be made by either typing in the name of the vendor or model number into a form field, or by selecting the desired vendor and model number from a computer generated selectable list. The software system of one embodiment of the present invention then automatically connects to central database 20 (see FIG. 5) to retrieve inventory information for each specified piece of merchandise (Step 346). Retailers using the software system access the database using a data transfer interface, such as but not limited to, over a computerized network such as the internet through an Ethernet or World Wide Web connection. System software then automatically inserts the downloaded product information into the appropriate fields within the retailers' inventory management program (Step 348). Alternatively, all product information on the database can be stored on a computer readable data storage device, such as a CDROM, DVDROM, or flash drive. Retailers can select merchandise stored on the storage device and have the corresponding information loaded into a purchase order form or into the retailer's inventory management program. The merchandise is then added to and saved in the inventory management system (Step 350). Additionally, a retailer or other end-user can selectively download only that portion of the product information in which he or she is interested, i.e. if the retailer only wants to download and display the product's image.

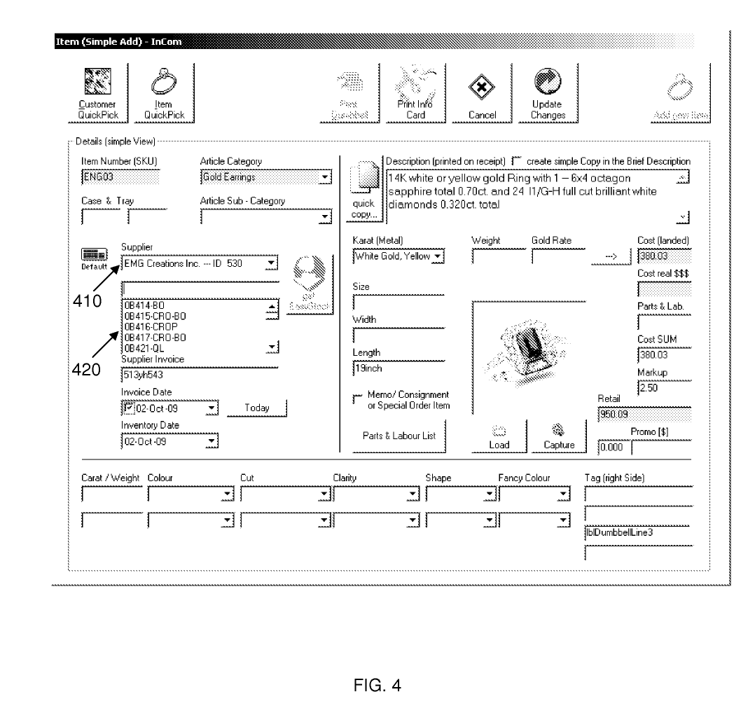

A screenshot of the software output in a preferred embodiment of the present invention is shown in FIG. 4. Importantly, the system and method described in FIG. 3 does not require any manual data entry other than selecting the vendor (FIG. 4 element 410) or the appropriate invoice number (not shown) and the specific item or items to be inventoried (FIG. 4, element 420). This greatly increases efficiency by reducing the time needed to insert new inventory into a retailer's inventory management program, while also minimizing user input errors as no manual data entry is required. Although specifically designed for use by jewelers, it is envisioned that the above described system and method can be extended to any appropriate supply chain, including but not limited to automobile parts distribution and sales, electronics and electronics maintenance, and retail appliances and repair.

FIG. 5 presents another possible embodiment of the present invention. In Step 510, a retailer selects merchandise from a supplier's e-catalog. More specifically, in Step 512, the information and properties of each piece are automatically retrieved by specialized software. Each vendor uses a different e-catalog software program and provides different items of information in differing locations within the catalog entry.

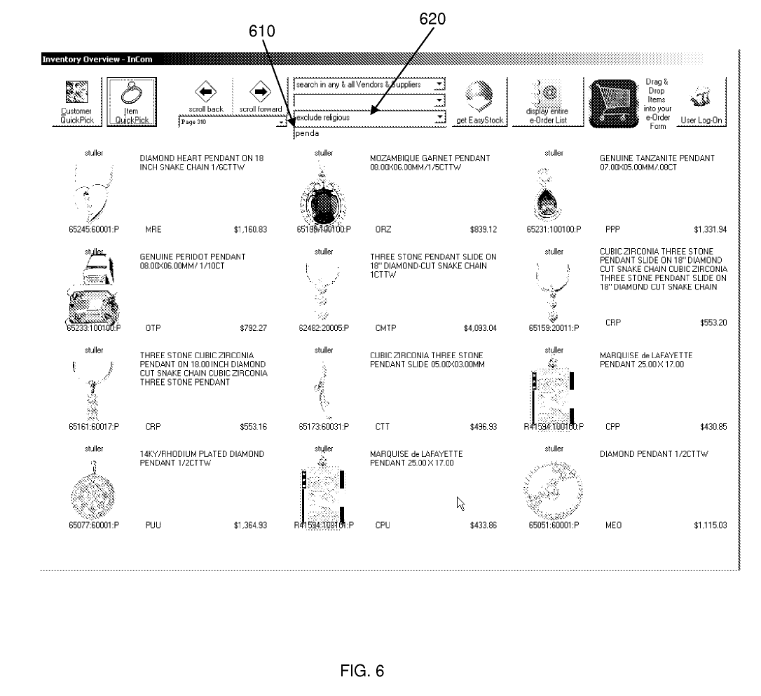

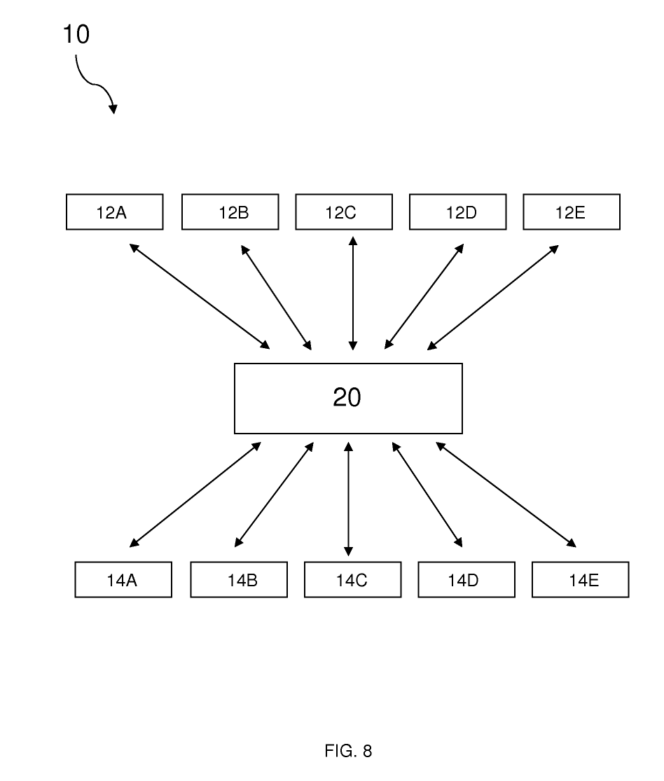

The software of the present invention standardizes the information provided by the vendors into a common format on the database 20 (see FIG. 8). Information is inputted, either manually or by software extraction, into standardized form fields and is displayed to retailers in a consistent format. This allows retailers to quickly and easily find and view specific information for any piece of merchandise without needing to read through an entire item description. Additionally, these form fields are searchable within the software. Therefore, if a retailer is looking for an item or items with a specific characteristic (i.e. a 0.5 karat marquise-cut diamond), the retailer enters these search criteria within a search query and the results are automatically presented. Alternatively, the multiple form fields are comprised of computer generated selectable lists such as drop-down menus (i.e. the metal used form field can have a drop down menu listing silver, gold, platinum, etc), and the like. Items can be searched by selecting specific characteristics within multiple form fields as this will successively narrow the number of items matching the desired characteristics. An example of this type of search is shown in FIG. 6. FIG. 6 shows a screenshot of the software output of a search for pendant (element 610) excluding religious designs (element 620). Importantly, once the product information is standardized on the database, it no longer needs to be manipulated. Therefore, manual input is limited to a one-time process and is done by the database provider and not by each of the individual retailers. This greatly reduces the chances of error while greatly increasing inventory management efficiencies.

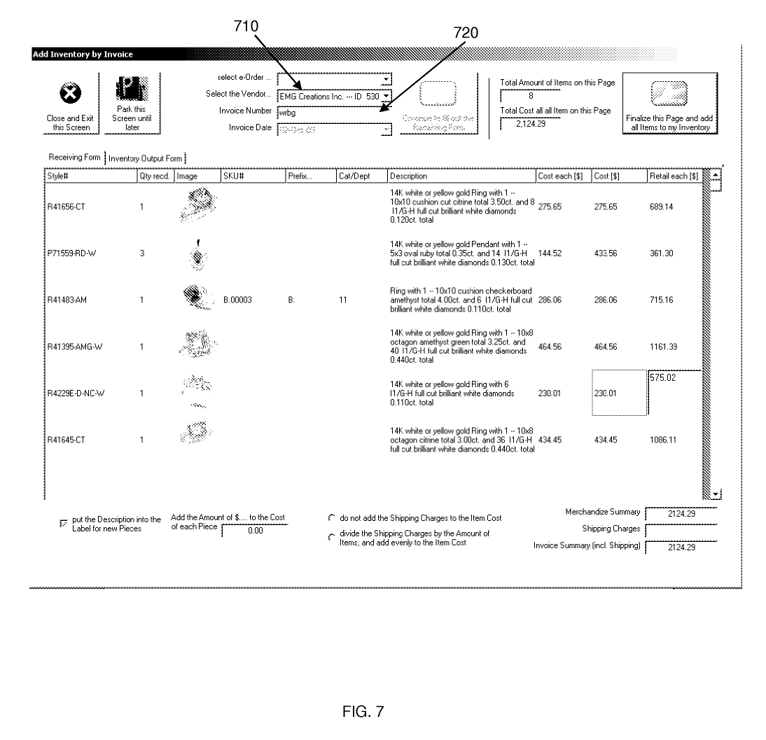

In Step 514 the selected product information is automatically inserted into the appropriate form fields within a purchase order form and saved as a pending order file on the retailer's computer. The retailer submits the pending order to vendors (Step 520) and the vendor ships the ordered merchandise to the retailer (Step 530). Steps 510 through 530 operate identically to Steps 310 through 330 described above. In Step 540, retailer recalls the stored Pending Order that was saved on retailer's computer at the time of submitting the order to the vender (i.e. Step 520). An example of the software output of the present invention illustrating Step 542 is shown in FIG. 7. The retailer needs only input or select from a computer generated selectable list the appropriate purchase order number, or the vendor from whom retailer received merchandise 710 and invoice number 720. The inventory management system software then automatically recalls and displays the information for each item on the order (Step 542). The retailer then reviews the order form and received merchandise to confirm that the correct items were ordered and received (Step 550). Once the merchandise has been confirmed, the inventory management system software automatically populates the retailer's inventory database placing the already downloaded item information into the appropriate fields (Step 552). Each item is then added to and saved in the inventory database (Step 560).

As can be seen, the embodiment shown in FIG. 5 requires minimal retailer action. A retailer only needs to select and order the desired merchandise. Once the merchandise has been received and is ready to be inventoried, the retailer need only compare and confirm the items received to the items ordered. The software system of this embodiment of the present invention accesses the central database and retrieves the stored information for each piece of merchandise. This information is presented to the retailer during preparation of the purchase order and is stored on the retailer's computer. Once the merchandise is received and confirmed, the system software automatically inputs the standardized information into the appropriate fields within the retailer's inventory management program. Thus, retailer action is minimized to selecting items from computer generated selectable lists and no manual input of information is required. This minimizes the possibility of input errors and greatly increases inventory management efficiency and accuracy.

Referring to FIG. 8, the inventory management system 10 comprises database 20, vendors 12A through 12E, and retailers 14A through 14E. Although shown as a single database, it is envisioned that the inventory management system of the present invention can be comprised of one or several shared databases. Database 20 is populated with the product catalog information from several vendors 12A through 12E. The product catalog information is varied and diverse and is received as either hardcopy supplier catalogs or in any kind of electronic format, such as databases, spreadsheets, text files, comma separated files, etc. To populate database 20, information is manually inputted, or electronically transferred from the supplied file as described above, into the database. In populating the database, catalog information from several vendors and therefore different layouts and formats, is standardized into a single format. Although five vendors are shown, it is understood that the current system can be contracted or expanded to include any number of vendors. Retailers 14A through 14E access database 20 using software and retrieve the catalog information. The retailer uses the software of the present invention to access database 20 and find all combined products within one system, rather than hunting for product information from several sources. The software allows a retailer to obtain information about one or several pieces at one time, and to retrieve the given information for each piece (i.e. product description, image, costs, etc.) during several retail functions (i.e. inventory receiving, ordering, and product browsing). Again, although five retailers are shown in this embodiment, the system of the present invention can be contracted or expanded to include any number of retailers or any other type of end-user, such as but not limited to purchasers and insurance companies.

Although the invention has been described with reference to certain preferred embodiments, it will be appreciated by those skilled in the art that modifications and variations may be made without departing from the spirit and scope of the invention. It should be understood that applicant does not intend to be limited to the particular details described above and illustrated in the accompanying drawings. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. An inventory management system comprising:
(a) a central database populated with product information from a supplier catalog from at least two suppliers wherein said product information is standardized into a common format;
(b) software capable of extracting said product information from said central database and inputting said product information into an end-user database; and
(c) an inventory management computer program running in said end-user database keeping track of end-user product inventory.

2. The inventory management system of claim 1 wherein said end-user is a jewelry retailer.

3. The inventory management system of claim 2 wherein said product is an article of jewelry.

4. The inventory management system of claim 1 wherein said extraction is through said software transferring data over a computerized network.

5. The inventory management system of claim 1 wherein said extraction is through said software transferring data from a computer readable data storage device.

6. The inventory management system of claim 1 wherein said inventory management computer program organizes said selected product information into a series of computer generated selectable lists categorized by each specific characteristic of a selected product.

7. A method for managing inventory comprising the following steps:
(a) providing a central database to be populated by product information from a supplier catalog;
(b) populating said central database with said product information from at least two suppliers;
(c) standardizing said product information from said at least two suppliers into a common format;
(d) providing to an end-user access to said central database to retrieve said standardized product information wherein said end-user selects at least one product to be purchased or received from one of said at least two suppliers;
(e) electronically storing said selected at least one product in a pending order file within an end-user's inventory management computer program;
(f) submitting said pending order to said one of at least two suppliers wherein said end-user recalls said stored pending order upon receipt of said at least one product and confirms receipt of said selected product from said supplier;
(g) downloading at least a portion of said product information for said confirmed product into said end-user's inventory management computer program.

8. The method of claim 7 wherein said access to said database comprises an interface between an end user's inventory management system and said database.

9. The method of claim 8 wherein said interface between said end user's inventory management system and said database is a computerized network connection.

10. The method of claim 8 wherein said interface between said end user's inventory management system and said database is a computer readable data storage device.

11. The method of claim 7 wherein said product information is automatically downloaded into said end-user's inventory management computer program using software capable of extracting said product information from said central database and inputting said product information into appropriate data fields within said end-user's inventory management computer program.

12. The method of claim 7 wherein said end-user is a jewelry retailer and said product is an article of jewelry.

13. The method of claim 12 wherein said inventory management computer program organizes said selected product information into a series of computer generated selectable lists categorized by each specific characteristic of said selected product wherein said specific characteristic is chosen from the metal used, size, width, length, weight, gender, product identifier, and whether for a special occasion.

14. A method for managing inventory comprising the following steps:
(a) providing a central database to be populated by product information from a supplier catalog;
(b) populating said central database with said product information from at least two suppliers;
(c) standardizing said product information from said at least two suppliers into a common format;
(d) providing to an end-user access to said central database to retrieve selected product information for one supplier wherein said end-user selects at least a portion of said standardized product information correlating to a selected product to be inventoried;
(e) downloading said selected product information for said selected product into an end-user's inventory management computer program.

15. The method of claim 14 wherein said access to said database comprises an interface between an end user's inventory management system and said database.

16. The method of claim 15 wherein said interface between said end user's inventory management system and said database is a computerized network connection.

17. The method of claim 15 wherein said interface between said end user's inventory management system and said database is a computer readable data storage device.

18. The method of claim 14 wherein said product information is automatically downloaded into said end-user's inventory management computer program using software capable of extracting said product information from said central database and inputting said product information into appropriate data fields within said end-user's inventory management computer program.

19. The method of claim 14 wherein said end-user is a jewelry retailer and said product is an article of jewelry.

20. The method of claim 19 wherein said inventory management computer program organizes said selected product information into a series of computer generated selectable lists categorized by each specific characteristic of said selected product wherein said specific characteristic is chosen from the metal used, size, width, length, weight, gender, product identifier, and whether for a special occasion.
